(19) United States
(12) Patent Application Publication
(10) Pub. No.: US 2025/0245063 A1
(43) Pub. Date: Jul. 31, 2025

(54) METHOD FOR LOAD PROCESSING, ELECTRONIC DEVICE AND STORAGE MEDIUM

(71) Applicant: BEIJING ZITIAO NETWORK TECHNOLOGY CO., LTD., Beijing (CN)

(72) Inventors: Shaohua GAO, Beijing (CN); Wenfeng LI, Beijing (CN)

(21) Appl. No.: 18/945,647

(22) Filed: Nov. 13, 2024

(30) Foreign Application Priority Data
Jan. 29, 2024 (CN) 202410122248.9

(51) Int. Cl. G06F 9/50

(52) U.S. Cl. CPC G06F 9/505

(57) ABSTRACT

The present disclosure provides a method for load processing, an electronic device and a storage medium. The method includes: acquiring a load state that is current for a target server; wherein the load state includes an overload state or an underload state, and an overload detection cycle corresponding to the overload state is less than an underload detection cycle corresponding to the underload state; and performing overload processing or underload processing on the target server based on the load state.

### CROSS-REFERENCE TO RELATED APPLICATION

The present application claims priority of the Chinese Patent Application No. 202410122248.9, filed Jan. 29, 2024, the disclosure of which is incorporated herein by reference in its entirety as part of the present application.

### TECHNICAL FIELD

The present disclosure relates to a method for load processing, an electronic device and a storage medium.

### BACKGROUND

In video conferencing scenarios, when the load of the media server accessed by users is too heavy, the users accessing the media server are denied access, so as to batch disconnect the media server from the stock users; and when the load of the media server is too low, a large number of users access the media server, which makes the media server oscillate between the overload state and the underload state, and causes the users accessing to the media service in an unstable state.

### SUMMARY

The present disclosure provides a method and apparatus for load processing, an electronic device and a storage medium.

One or more embodiments of the present disclosure provide a method for load processing. The method includes:
acquiring a load state that is current for a target server; in which the load state includes an overload state or an underload state, and an overload detection cycle corresponding to the overload state is less than an underload detection cycle corresponding to the underload state; and
performing overload processing or underload processing on the target server based on the load state.

One or more embodiments of the present disclosure provide an apparatus for load processing, which includes: a load state acquiring module and a load processing module.

The load state acquiring module is configured to acquire a load state that is current for a target server; in which the load state includes an overload state or an underload state, and an overload detection cycle corresponding to the overload state is less than an underload detection cycle corresponding to the underload state.

The load processing module is configured to perform overload processing or underload processing on the target server based on the load state.

One or more embodiments of the present disclosure provide an electronic device. The electronic device includes a memory and a processor. The memory stores a computer program, and when the processor executes the program, the processor implements the method for load processing provided by any embodiment of the present disclosure.

One or more embodiments of the present disclosure provide a non-transitory computer-readable storage medium, which stores a computer program. When the program is executed by a processor, the processor is caused to implement the method for load processing provided by any embodiment of the present disclosure.

### BRIEF DESCRIPTION OF DRAWINGS

In the following description of exemplary embodiments in conjunction with the drawings, more details, features and advantages of the present disclosure are disclosed in the drawings.

FIG. 1 is a schematic diagram of adjusting the state of a media server provided by an exemplary embodiment of the present disclosure;

FIG. 2 is a flowchart of adjusting the state of a media server provided by an exemplary embodiment of the present disclosure;

FIG. 3 is a flowchart of the method for load processing provided by an exemplary embodiment of the present disclosure;

FIG. 4 is a schematic block diagram of function modules of the apparatus for load processing provided by an exemplary embodiment of the present disclosure;

FIG. 5 is a structural block diagram of an electronic device provided by an exemplary embodiment of the present disclosure; and

FIG. 6 is a structural block diagram of a computer system provided by an exemplary embodiment of the present disclosure.

### DETAILED DESCRIPTION

The embodiments of the present disclosure will be described in more detail below regarding the drawings. Although certain embodiments of the present disclosure are shown in the drawings, it should be appreciated, nevertheless, that the present disclosure may be realized in various forms and should not be construed as being limited to the embodiments described herein, but rather are provided for a more thorough and complete understanding of the present disclosure. It should be understood that the drawings and embodiments of the present disclosure are for exemplary purposes only and are not intended to limit the scope of protection of the present disclosure.

It should be understood that the various steps described in the embodiments for the method of the present disclosure may be performed in a different order, and/or in parallel. Furthermore, the embodiments for the method may include additional steps and/or omit performing the steps described. The scope of the present disclosure is not limited in this regard.

The term “including” and its variations are used herein as an open-ended inclusion, i.e. “including but not limited to”. The term “based on” is “based at least in part on”. The term “one embodiment” means “at least one embodiment”; the term “another embodiment” means “at least one additional embodiment”; the term “another embodiment” means “at least one other embodiment”; and the term “some embodiments” means “at least some embodiments”. Related definitions of other terms will be given in the following description. It should be noted that the concepts of “first”, “second” and the like mentioned in the present disclosure are only used to differentiate different devices, modules or units, and are not used to define the order or interdependence of the functions performed by the devices, modules or units.

It should be noted that the modifications of “one” and “more than one” mentioned in the present disclosure are schematic and not restrictive. Those skilled in the art should understand that “one or more” is to be understood unless the context clearly indicates otherwise.

In the embodiments of the present disclosure, the names of the messages or information that interacted between the plurality of apparatuses are used for illustrative purposes only, and are not intended to limit the scope of the messages or information.

It is to be understood that before performing the technical schemes disclosed in each embodiment of the present disclosure, the user should be informed of and authorized to type of personal information, scope of use, and scenario of use involved in the present disclosure by relevant laws and regulations and in an appropriate manner.

For example, in response to receiving an unsolicited request from the user, a prompting message is sent to the user to explicitly prompt the user that the operation requested to be performed will require access to and use of the user's personal information. Thus, the user is enabled to independently choose, based on the prompting message, whether or not to provide the personal information to software or hardware, such as an electronic device, an application, a server, or a storage medium, which performs the operation of the technical schemes of the present disclosure.

As an optional but non-limiting realization, in response to receiving an unsolicited request from the user, the manner of sending the prompting message to the user may be, such as, a pop-up window, in which the prompting message may be presented in the form of text. In addition, the pop-up window may contain an option control for the user to select “agree” or “disagree” to provide the personal information to the electronic device. It is understood that the above notification and user authorization process is only schematic and does not limit the implementation of the present disclosure, and other methods that satisfy the relevant laws and regulations may also be used in the implementation of the present disclosure.

In a video conferencing scenario, in response to an overload phenomenon of a media server, the relevant technology usually kicks out the users currently accessing to the media server in batches and denies access to new users. However, the batch of users who are denied access or kicked out need to re-access to another media server and re-establish a new connection.

When the batch of the users access to another media server, it may lead to the overload phenomenon of the newly accessed media server. It may also trigger that the newly accessed media server initiates the behaviors of kicking out the users and denying the access from the new users, which is not conducive to the stability of the server cluster and affects the users' access to a stable conference video stream.

Therefore, to solve the above technical problems, the embodiments of the present disclosure may cyclically acquire a load state of a media server. For example, the load rate of the media server may be collected every 3 seconds, so that the load rate in the most recent cycle can be used as a sample. In the embodiments, the load rate of the media server may be determined by the occupancy rate of the CPU (Central Processing Unit), and the embodiments are not limited thereto.

For example, an edge media server may collect the average value of the CPU in the most recent cycle as a sample every 3 seconds interval, i.e., at the time Tn, the average occupancy rate of the CPU between Tn−1˜Tn is calculated. At the time Tn+1, the average occupancy rate of the CPU between Tn˜Tn+1 is calculated, and the load rate of the media server in that cycle is reported.

To reduce the CPU surge caused by Garbage Collection (GC), which affects the judgment of the scheduling server on the multimedia load rate, the load rate reported by the media server to the scheduling server may refer to the nearest sampling point after excluding GC in the last 3 cycles (e.g., 3 sampling points in 9 seconds), which is taken as the LocalCpu, and the LocalCpu is reported to the scheduling server. The LocalCpu represents the load rate of the most recent cycle of the single-machine local.

The scheduling server may receive the LocalCpu reported by each media server in a media server cluster, and aggregate the LocalCpu as an average ClusterCpu of the server cluster, in which the average ClusterCpu represents the average load rate of the cluster for the most recent cycle.

When an overload degradation strategy is adopted to the media server, the load rate of the media server may be reduced. When the overload degradation strategy is withdrawn, the load of the media server will recover, and the overload degradation strategy needs to be adopted again. This phenomenon is called the breathing effect. In order to reduce the CPU oscillation caused by the breathing effect, which makes the user experience repetitive, the embodiments of the present disclosure adopt a slow recovery strategy for state transition, i.e., setting an overload detection cycle and an underload detection cycle respectively. The overload detection cycle is less than the underload detection cycle, and the condition for entering the overload detection cycle is decreased while the condition for entering the underload detection cycle is raised. Through the asymmetric design, the media server will not easily enter the underload state when the media server is in the overload state, and the problems such as CPU oscillation caused by the breathing effect can be avoided to a large extent.

Specifically, the overload detection can be performed on the media server in the following manner:
continuously acquiring the ClusterCpu for N cycles and the OverLoadClusterLimit of N consecutive cycles, and continuously acquiring the LocalCpu for N cycles and the OverLoadLocalLimit of N consecutive cycles. In response to the ClusterCpu being greater than the OverLoadClusterLimit in the N consecutive cycles, or the LocalCpu being greater than the OverLoadLocalLimit in N consecutive cycles, it is determined that the media server is in the overload state. The OverLoadClusterLimit denotes an overload threshold value for the load rate of the server cluster, and the OverLoadLocalLimit denotes an overload threshold value for the single-machine load rate. It should be noted that each threshold value in the embodiments can be set according to actual needs, and the threshold values in the embodiments may be empirical values, and the embodiments are not limited thereto.

The underload detection may be performed on the media server in the following manner:
continuously acquiring the ClusterCpu for M cycles and the UnderLoadClusterLimit of M consecutive cycles, and continuously acquiring the LocalCpu for M cycles and the UnderLoadLocalLimit of M consecutive cycles. In response to the ClusterCpu being less than OverLoadClusterLimit in M consecutive cycles, or the LocalCpu being less than OverLoadLocalLimit in M consecutive cycles, it is determined that the media server is in the underload state. The N is less than the M, and the N and the M are both positive integers. The UnderLoadClusterLimit denotes an underload threshold value for the load rate of the server cluster, and the UnderLoadLocalLimit denotes an underload threshold value for the single-machine load rate. The OverLoadClusterLimit is greater than the UnderLoadClusterLimit, and the OverLoadLocalLimit is greater than the UnderLoadLocalLimit.

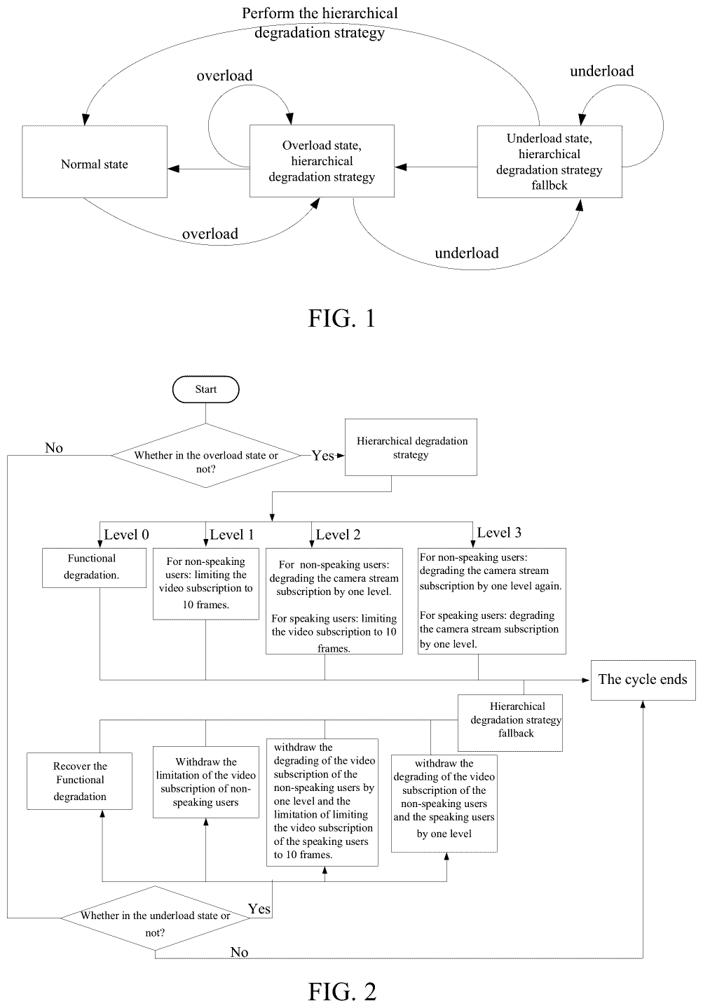

In an embodiment, as shown in FIG. 1, FIG. 1 is a schematic diagram of adjusting the state of a media server in the embodiment of the present disclosure. When the media server is in the normal state, the load rate of the media server may be cyclically detected. For example, each media server in the server cluster collects information such as the occupancy rate of the CPU at regular intervals to acquire the load rate. The load rate may be the occupancy rate of the CPU. Each media server cyclically reports the load rate, so that the scheduling server can acquire the load rate of each media server and the average load rate of the server cluster in the past period.

As shown in FIG. 1, for a target media server in the server cluster, in response to the target media server being in the normal state, the load rate of the target media server and the average load rate of the server cluster are detected cyclically. Then, by means of the embodiment described above, when it is determined that the state of the target media server changes from the normal state to the overload state, the hierarchical degradation strategy is performed on the target media server. The multimedia data stream accessed to the target media server is gradually reduced by the hierarchical degradation strategy. In the video conferencing scenario, the multimedia data stream may specifically be a multimedia conference data stream or a multimedia video data stream, etc.

In an embodiment, when the target media server is in the overload state, the media server is de-loaded by the hierarchical degradation strategy to reduce the load rate of the target media server. After performing the hierarchical degradation strategy on the target media server, the load rate of the target media server may be detected again. In response to the target media server still being in the overload state, the hierarchical degradation strategy may be performed again to increase the degradation level of the hierarchical degradation strategy, i.e., increase the degree of de-loading the target media server until the target media server is not in the overload state.

When the target media server is detected to return to the normal state, the hierarchical degradation strategy is stopped. When the target media server is detected to be in the underload state, hierarchical degradation strategy fallback is performed, i.e., reducing the level corresponding to the hierarchical degradation strategy to increase the load rate of the target media server. In response to the target server still being in the underload state, the level of the hierarchical degradation strategy may be reduced again until the target media server is not in the underload state. In response to the target media server being detected to be in the normal state, the hierarchical degradation strategy fallback is stopped. The level of the hierarchical degradation strategy may be increased when the target media server is in the overload state.

In an embodiment, taking a video conference scenario as an example, since the number of speaking users is generally limited, most users participate in the conference as non-speaking users. The non-speaking users generally do not or are less likely to speak through a microphone and turn on a camera. Therefore, the embodiments may divide the users in the video conference scenario into two types of users, speaking users and non-speaking users.

For the speaking users, they are free to speak, turn on the camera and switch views. The speaking users are the information makers of a conference, always have decision-making power, so the experience of the speaking users in the video conferencing scenario needs to be prioritized. The data stream generated by the speaking users' cameras may be a multi-resolution size stream, which can be switched on the media server.

For the non-speaking users, by default, they cannot speak, can only subscribe to the audio and video streams of the speaking users, and cannot switch the view. Non-speaking users can be the recipients of conference information. The main information of a conference is almost always conveyed through “sound” or “sharing”, so the quality of the sound and sharing of a conference needs to be prioritized.

Therefore, for the video conference scenario, the hierarchical degradation strategy in the above embodiments ensure that the priority of audio is higher than the priority of screen sharing, the priority of screen sharing is higher than the priority of the camera, and the priority of the speaking users is higher than the priority of the non-speaking users. For videos, the priority of the main video is higher than the priority of the non-main video, the main video can include high-resolution videos, and the non-main video can include small images or low-resolution videos, etc. When performing the hierarchical degradation strategy, the lower priority is degraded firstly to reduce the impact on the user.

The principle of the hierarchical degradation strategy is from the low level to the high level, and the principle of the hierarchical degradation strategy fallback is from the current level to the lower level.

Therefore, the hierarchical degradation strategy described above in the embodiment may include a plurality of levels. The hierarchical degradation strategy including four levels is taken as an example to illustrate the embodiment. Specifically, the hierarchical degradation strategy can also be divided according to different scenarios and situations, and the embodiment is not limited thereto.
Level 0, functional degradation: limiting the proportion of redundant transmission.
Level 1, for non-speaking users: limiting the number of frames of the video subscription, for example, limiting the video subscription to 10 frames, i.e., the frame rate of the transmission, and the number of frames transmitted per second;
   for speaking users: no restriction.
Level 2, for non-speaking users: degrading the camera stream subscription by one level from the level of the current subscription;
   for speaking users: limiting the video subscription to 10 frames.
Level 3, for non-speaking users: degrading the camera stream subscription by one level from the level of the current subscription again;
   for speaking users: degrading the camera stream subscription by one level from the level of the current subscription.

As shown in Table 1, Table 1 shows the default frame rate corresponding to different resolutions, and the degraded resolution corresponding to the degraded frame rate.

TABLE 1

| | | Degraded frame | |
|---|---|---|---|
| Resolution | Default frame rate | rate | Degraded resolution |
| 1280*720 | 24 | 10 | 640*360 |
| 640*360 | 24 | 10 | 320*180 |
| 320*180 | 15 | 10 | 160*90 |
| 160*90 | 12 | 10 | 0 |

The hierarchical degradation strategy fallback is performed when the target media server is in the underload state. In the embodiment, it can acquire the level corresponding to the current corresponding hierarchical degradation strategy, and roll back the corresponding degradation strategy. In response to the target media continuously being in the underload state, the hierarchical degradation strategy fallback is performed. in response to the target media being in the overload state, then the hierarchical degradation strategy is performed on the target media server.

As described in FIG. 2, which shows the hierarchical degradation strategy performed on the target media server during the overload detection and the hierarchical degradation strategy fallback performed on the target media server during the underload detection respectively, in the embodiment of the present disclosure.

Specifically, in conjunction with FIG. 2, the overload detection is performed on the target multimedia server. When the target media server is detected to be in the overload state, the scheduling server may send degraded notification information to the target media server, and the target media server performs a hierarchical degradation strategy when receiving the degraded notification information.

When the target media server is currently at Level 0, the target media server performs the functional degradation, for example, including setting a limited redundancy ratio of the multimedia conference data stream transmission, or a limited ratio of packet-loss retransmission, and so on. The functional degradation is performed and the current degradation cycle ends.

When the target media server is detected to be in the overload state in the next cycle, the level of the hierarchical degradation strategy is increased, for example, from the original Level 0 to Level 1. The degradation to Level 1 restricts the video subscription of all non-speaking users, limiting the frame rate of the video subscription. For example, the original default frame rate of the video subscription of the non-speaking users is 24 frames (i.e., 24 frames of video are transmitted per second). At the Level 1, the video subscription of the non-speaking users is restricted, for example, the video subscription can be restricted to 10 frames, and then the degradation cycle of the hierarchical degradation strategy ends. The purpose of limiting the video subscription of the non-speaking users to 10 frames is to reduce the number of packets sent by the target media server and to reduce the load rate of the target media server, i.e., to reduce the occupancy rate of the CPU of the target media server.

When the target media server is detected to be in the overload state again in the next cycle, de-loading processing is performed on the target media server by further increasing the level of the hierarchical degradation strategy from the original Level 1 to Level 2. At the Level 2, the video subscription of all non-speaking users is degraded by one level. For example, when the original video subscription of non-speaking users has a resolution of 360 P, the resolution of the video subscription will be decreased from 360 P to 180 P; when the original video subscription of non-speaking users has a resolution of 180 P, the resolution of the video subscription will be further decreased to 90 P, at the same time, the video subscription of speaking users will be correspondingly limited or further degraded by one level, for example, the video subscription of the speaking users is limited to 10 frames, so as to achieve the purpose of gradually reducing the load rate of the target media server, and the amount of multimedia conferencing data streams transmitted by the target media server can be reduced by reducing the resolution of the video subscription, which can reduce the load rate of the target media server.

When the target media server is detected to be in the underload state and is at Level 2 corresponding to the hierarchical degradation strategy, the target media server falls back to the state before Level 2. For example, at Level 2, the video subscription of the non-speaking users is degraded by one level, and the video subscription of the speaking users is limited to 10 frames, performing the hierarchical degradation fallback is to withdraw the degrading of the video subscription of the non-speaking users by one level. It can be interpreted as upgrading the video subscription of the non-speaking users by one level, and withdrawing the limitation of limiting the video subscription of the speaking users to 10 frames.

For each level of the hierarchical degradation strategy, the degradation strategies for non-speaking and speaking users are different. In response to the target media server being in the underload state, it is required to fall back to the state corresponding to the current level before the degradation.

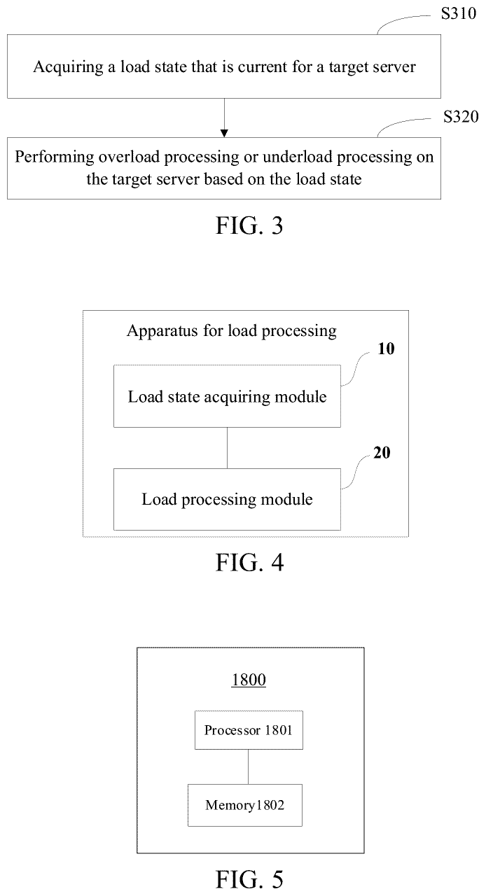

Based on the above embodiments, in another embodiment provided by the embodiments of the present disclosure, it is also provided a method for load processing, as shown in FIG. 3, the method may include the following steps.

In S310: acquiring a load state that is current for a target server.

The load state includes an overload state or an underload state, and an overload detection cycle corresponding to the overload state is less than an underload detection cycle corresponding to the underload state.

In S320: performing overload processing or underload processing on the target server based on the load state.

In an embodiment, the target server may specifically be a target media server, and can acquire a current load state of the target media server based on the above-described manners. For example, when the target media server is in the overload state, the hierarchical degradation strategy is performed on the target media server to reduce the current load rate of the target media server. Similarly, when the target media server is in the underload state, the hierarchical degradation strategy fallback is performed on the target media server to increase the current load rate of the target media server, so that the target media server is in a normal state.

The embodiment of the present disclosure provides the method for load processing, which includes acquiring the current load state of the target server, and performing the overload processing or the underload processing on the target server based on the load state. The load state includes the overload state or the underload state, and the overload detection cycle corresponding to the overload state is less than the underload detection cycle corresponding to the underload state, so that the target server will not easily enter the underload state. Thus, the target server is less likely to oscillate between the overload state and the underload state, and the stability of the users accessing to the target server can be improved.

In an embodiment, detection conditions may be set for the above overload state and underload state respectively. For the detection of the overload state, it may be implemented by the step of acquiring an average load rate of a server cluster where the target server is located and a single-machine load rate of the target server, in response to, during the overload detection cycle, the average load rate being greater than a first threshold value, or the single-machine load rate being greater than a second threshold value, determining that the current load state of the target server is the overload state.

In an embodiment, for the underload state detection, it may be implemented by the step of determining that the current load state of the target server is the underload state in response to the average load rate being less than a third threshold value during the underload detection cycle, and the single-machine load rate being less than a fourth threshold value during the underload detection cycle. The third threshold value is less than the first threshold value, and the fourth threshold value is less than the second threshold value.

In an embodiment, the above first threshold value may be the corresponding overload threshold value for the load rate of a cluster, OverLoadClusterLimit in the above embodiment; the second threshold value may be the overload threshold value for the single-machine load rate, OverLoadLocalLimit in the above embodiment; the third threshold value may be the underload threshold value for the load rate of a cluster, UnderLoadClusterLimit in the above embodiment; and the fourth threshold value may be the underload threshold value for the single-machine load rate, UnderLoadLocalLimit corresponding to the above embodiment.

In an embodiment, when performing the underload detection, it is required to simultaneously satisfy that the average load rate of the server cluster is less than the third threshold value during the underload detection cycle, and the single-machine load rate for the target server is less than the fourth threshold value during the underload detection cycle. When performing the overload detection, it is only required to satisfy any situation that the average load rate of the server cluster is greater than the first threshold value during the overload detection cycle, or the single-machine load rate for the target server is greater than the second threshold value, and the overload detection cycle is less than the underload detection cycle. It makes it easier for the target server to enter the overload state detection rather than the underload state, i.e., after de-loading the target server, the target server will not enter the underload state again very soon, which will not cause the target server to enter the overload state again very soon, and can avoid the problems such as CPU oscillation caused by the breathing effect to a large extent.

Based on the above embodiments, in another embodiment provided in the present disclosure, the above S320 may specifically further include the following steps.

In S321: acquiring an accessor that accesses to the target server, and sending a multimedia data stream to a plurality of accessors;

In S322: performing a hierarchical degradation strategy on the multimedia data stream in response to the target server being in the overload state, in which the hierarchical degradation strategy is used to gradually reduce data transmission amount of the multimedia data stream.

In an embodiment, taking a video conferencing scenario as an example, the target server may be a target media server, which may receive, for example, multimedia data streams sent by the speaking users and the non-speaking users as described above, and the multimedia data stream may be an audio-video stream and the like.

The target media server, when receiving subscription information of a user, may forward the multimedia data stream to the subscribers based on the subscription information. Or the target media server may combine the audio and video streams sent by a plurality of subscribers into one video stream, and then sending the one video stream to the subscribers. The embodiments are not limited thereto.

Therefore, when the target media server is in the overload state, in order to reduce the load rate of the target media server, it is required to perform a de-loading process on the target media server to reduce the load rate of the target server. In an embodiment, the de-loading process can be performed on the target media server specifically by the hierarchical degradation strategy. The hierarchical degradation strategy is not to reduce the accessors that have accessed to the target media server, i.e., not to deny access to the stock users, but to gradually reduce the transmission amount of the multimedia data stream sent to the accessors that have accessed to the target media server. For example, the load rate of the target media server is reduced by decreasing the quality of the video in the multimedia data stream, or reducing redundancy in data transmission, and so on, which can avoid the unstable situation caused by the user needing to constantly move between accessing the server and de-accessing the server, and improve the stability of the user acquiring the audio and video streams.

In an embodiment, hierarchical degradation strategy fallback is performed on the multimedia data stream when the target server is in the underload state. The hierarchical degradation strategy fallback is used to gradually increase the data transmission amount of the multimedia data stream. When the target server is in the underload state, the hierarchical degradation strategy fallback is performed on the multimedia data stream to increase the data transmission amount of the multimedia data stream, so that the target server returns to a normal state and the resource utilization rate of the target server is improved.

Specifically, the hierarchical degradation strategy may include a plurality of levels, and the data transmission amount of the multimedia data stream may be reduced level by level based on the plurality of levels included in the hierarchical degradation strategy. For example, by the above embodiment, the hierarchical degradation strategy may include four levels, different levels correspond to different extents of reducing the data transmission amount of the multimedia data stream. The data transmission amount of the multimedia data stream may be started to be reduced from the lowest level in a cycle. In response to the target server still being in the overload state in the next cycle, the level of the hierarchical degradation strategy is increased, which further reducing the data transmission amount of the multimedia data stream until the target server is not in the overload state.

Based on the above embodiments, in another embodiment provided in the present disclosure, the data transmission amount of the multimedia data stream may also be reduced by acquiring an accessor category corresponding to the accessor, and reducing the data transmission amount of the multimedia data stream based on the accessor category.

Specifically, the accessors that have accessed to the target server may be divided into different categories, and the accessors of different categories have different priority levels. Thus, the data transmission amount of the multimedia data stream of the accessors that have a lower priority level may be preferentially reduced, so as to ensure the data transmission amount of the multimedia data stream of the accessors that have a high priority level.

Specifically, it can refer to the above embodiment, the users are divided into speaking users and non-speaking users, combined with the hierarchical degradation strategy of different levels, the multimedia data corresponding to the speaking users and non-speaking users are respectively degraded for data transmission, and the priority of the speaking users is higher than that of the non-speaking users. In this way, by prioritizing decreasing the multimedia data transmission quality of the non-speaking users, the multimedia data transmission quality of the speaking users is ensured as much as possible, and the users' experience can be improved to a large extent.

In the embodiment, in response to the load state being the overload state, the level of the hierarchical degradation strategy may be increased. Alternatively, in response to the load state being the underload state, the level of the hierarchical degradation strategy may be decreased. In response to the target server being continuously detected to be in the overload state, the level of the hierarchical degradation strategy needs to be increased in the next detection cycle to further reduce the load of the target server. Similarly, in response to the target server being continuously detected to be in the underload state, the level of the hierarchical degradation strategy needs to be decreased in the next detection cycle to further increase the load of the target server, making the target server in a normal state. Details can be found in the description of the above embodiments, which will not be repeated here.

In the case of adopting the division of individual functional modules corresponding to individual functions, embodiments of the present disclosure provide an apparatus for load processing, which may be a server, a terminal, or a chip applied to a server. FIG. 4 shows a schematic block diagram of functional modules of the apparatus for load processing provided by an exemplary embodiment of the present disclosure. As shown in FIG. 4, the apparatus for load processing includes a load state acquiring module 10 and a load processing module 20.

The load state acquiring module 10 is configured to acquire a load state that is current for a target server, in which the load state includes an overload state or an underload state, and an overload detection cycle corresponding to the overload state is less than an underload detection cycle corresponding to the underload state.

A load processing module 20 is configured to perform overload processing or underload processing on the target server based on the load state.

In another embodiment provided in the present disclosure, the apparatus further includes a load rate acquiring module and an overload state determining module.

The load rate acquiring module is configured to acquire an average load rate of a server cluster where the target server is located and a single-machine load rate of the target server.

The overload state determining module is configured to determine that a current load state of the target server is the overload state, in response to, during the overload detection cycle, the average load rate being greater than a first threshold value, or the single-machine load rate being greater than a second threshold value.

In another embodiment provided in the present disclosure, the apparatus further includes:
an underload state determining module, which is configured to determine that the current load state of the target server is the underload state, in response to, during the underload detection cycle, the average load rate being less than a third threshold value, and the single-machine load rate being less than a fourth threshold value; in which the third threshold value is less than the first threshold value, and the fourth threshold value is less than the second threshold value.

In another embodiment provided in the present disclosure, the load processing module is specifically configured to:
acquire an accessor that accesses to the target server and send a multimedia data stream to the accessor; and
perform a hierarchical degradation strategy on the multimedia data stream in response to the target server being in the overload state, in which the hierarchical degradation strategy is used to gradually reduce data transmission amount of the multimedia data stream.

In another embodiment provided in the present disclosure, the apparatus further includes:
a hierarchical degradation strategy fallback module, which is configured to perform a hierarchical degradation strategy fallback on the multimedia data stream in response to the target server being in the underload state, in which the hierarchical degradation strategy fallback is used to gradually increase the data transmission amount of the multimedia data stream.

In another embodiment provided in the present disclosure, the hierarchical degradation strategy includes a plurality of levels; and the hierarchical degradation strategy fallback module is specifically configured to:
reduce the data transmission amount of the multimedia data stream level by level based on the plurality of levels included in the hierarchical degradation strategy.

In another embodiment provided in the present disclosure, the apparatus further includes a category acquisition module and a data transmission amount reduction module.

The category acquisition module is configured to acquire an accessor category corresponding to the accessor.

The data transmission amount reduction module is configured to reduce the data transmission amount of the multimedia data stream based on the accessor category.

In another embodiment provided in the present disclosure, the apparatus further includes a level increasing module and a level decreasing module.

The level increasing module is configured to increase a level of the hierarchical degradation strategy in response to the load state being the overload state.

The level decreasing module is configured to decrease the level of the hierarchical degradation strategy in response to the load state being the underload state.

The relevant apparatus portion, corresponding to the above method, is described in detail in the corresponding embodiment of the above method and will not be repeated herein.

The apparatus for load processing provided by the embodiments of the present disclosure, by acquiring a current load state of the target server and based on the load state, performs overload processing or underload processing on the target server. The load state includes the overload state or the underload state, and since the overload detection cycle corresponding to the overload state is less than the underload detection cycle corresponding to the underload state, the target server will not easily enter the underload state. It makes the target server less likely to oscillate between the overload state and the underload state, and the stability of the users accessing the target server can be improved.

The embodiments of the present disclosure further provide an electronic device, which includes at least one processor and a memory. The memory is configured to store instructions executable for the at least one processor. The at least one processor is configured to execute the instructions to implement the above method disclosed by embodiments of the present disclosure.

FIG. 5 shows a structural block diagram of an electronic device provided by an exemplary embodiment of the present disclosure. As shown in FIG. 5, the electronic device 1800 includes at least one processor 1801 and a memory 1802 coupled to the processor 1801. The processor 1801 may perform the corresponding steps in the above method disclosed by embodiments of the present disclosure.

The processor 1801 may also be referred to as a central processing unit (CPU), which may be an integrated circuit chip with signal processing capability. The steps in the above described method disclosed in the embodiments of the present disclosure may be implemented by integrated logic circuits of hardware in the processor 1801 or by instructions in the form of software. The above described processor 1801 may be a general-purpose processor, a DSP (digital signal processing), an ASIC (Application Specific Integrated Circuit), an FPGA (field-programmable gate array) or other programmable logic device, discrete gate or transistor logic device, and discrete hardware components. The general-purpose processor may be a microprocessor or the processor may be any conventional processor, etc. The steps of the method disclosed in conjunction with embodiments of the present disclosure may be directly embodied in a hardware decoding processor executing to perform, or executing to perform with a combination of hardware and software modules in the decoding processor. The software module may be located in the memory 1802, such as random memory, flash memory, read-only memory, programmable read-only memory or electrically erasable programmable memory, registers, and other storage media well established in the art. The processor 1801 reads the information in the memory 1802 and completes the steps of the method described above in conjunction with its hardware.

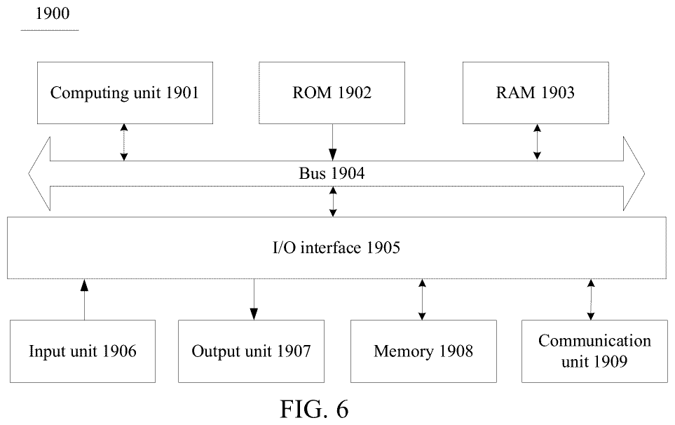

Alternatively, various operations/processing in accordance with the present disclosure may be realized by software and/or firmware in the case of installing a program constituting such software from a storage medium or a network to a computer system having a dedicated hardware structure, such as the computer system 1900 shown in FIG. 6. The computer system is capable of performing various functions when various programs are installed, including functions such as those previously described, and the like. FIG. 6 shows a structural block diagram of a computer system provided by an exemplary embodiment of the present disclosure.

The computer system 1900 is intended to represent various forms of digital electronic computing devices such as, laptops, desktop computers, workstations, personal digital assistants, servers, blade servers, mainframe computers, and other suitable computers. Electronic devices may also denote various forms of mobile devices such as, personal digital processing, cellular phones, smart phones, wearable devices, and other similar computing devices. The components shown herein, their connections and relationships, and their functions are shown as examples only and are not intended to limit the implementations of the present disclosure described and/or claimed herein.

As shown in FIG. 6, the computer system 1900 includes a computing unit 1901 that can perform a variety of appropriate actions and processes based on a computer program stored in a read-only memory (ROM) 1902 or a computer program loaded from a storage unit 1908 into a random access memory (RAM) 1903. In the RAM 1903, various programs and data required for the operation of the computer system 1900 may also be stored. The computing unit 1901, the ROM 1902, and the RAM 1903 are connected via the bus 1904. The Input/output (I/O) interface 1905 is also connected to the bus 1904.

A plurality of components of the computer system 1900 are connected to the I/O interface 1905, including an input unit 1906, an output unit 1907, a storage unit 1908, and a communication unit 1909. The input unit 1906 may be any type of device capable of inputting information into the computer system 1900, and may receive incoming numeric or character information, as well as generate key signal inputs related to user settings and/or function control of the electronic device. The output unit 1907 may be any type of device capable of presenting information and may include, but is not limited to, a display, a speaker, a video/audio output terminal, a vibrator, and/or a printer. The storage unit 1908 may include, but is not limited to, a disk, an optical disk. The communication unit 1909 allows the computer system 1900 to exchange information/data with other devices over a network such as the Internet's and may include, but is not limited to, a modem, a network card, an infrared communication device, a wireless communication transceiver and/or a chipset such as a Bluetooth device, a WiFi device, a WiMax device, a cellular communication device, and/or the like.

The computing unit 1901 may be a variety of general-purpose and/or specialized processing components with processing and computational capabilities. Some examples of the computing unit 1901 include but are not limited to, a central processing unit (CPU), a graphics processing unit (GPU), a variety of specialized artificial intelligence (AI) computing chips, a variety of computing units running machine learning modeling algorithms, a digital signal processor (DSP), and any suitable processors, controllers, microcontrollers, and the like. The computing unit 1901 performs the various methods and processes described above. For example, in some embodiments, the above-described methods disclosed in embodiments of the present disclosure may be implemented as a computer software program that is tangibly contained in a machine-readable medium, such as a storage unit 1908. In some embodiments, some or all of the computer program may be loaded and/or installed onto an electronic device via ROM 1902 and/or communication unit 1909. In some embodiments, the computing unit 1901 may be configured to perform the above-described methods disclosed by embodiments of the present disclosure by any other suitable means (e.g., with the aid of firmware).

The embodiments of the present disclosure also provide a computer-readable storage medium, in which the computer-readable storage medium, when executed by a processor of an electronic device, enables the electronic device to perform the above-described methods disclosed in the embodiments of the present disclosure.

The computer-readable storage medium in the embodiments of the present disclosure may be a tangible medium that may contain or store a program for use by or in conjunction with an instruction execution system, device, or apparatus. The computer-readable storage medium may include, but is not limited to, an electronic, magnetic, optical, electromagnetic, infrared, or semiconductor system, device, or apparatus, or any suitable combination of the foregoing. More specifically, the above described computer-readable storage medium may include an electrical connection based on one or more wires, a portable computer disk, a hard disk, a random access memory (RAM), a read-only memory (ROM), an erasable programmable read-only memory (EPROM or flash memory), a fiber-optic, a convenient compact disk read-only memory (CD-ROM), an optical storage device, a magnetic storage device or any suitable combination of the foregoing.

The above described computer-readable medium may be contained in the above-described electronic device; or it may stand alone and not be assembled into that electronic device.

The embodiments of the present disclosure also provide a computer program product including a computer program, when executed by a processor, implements the method disclosed by the embodiments of the present disclosure.

In the embodiments of the present disclosure, computer program code for performing the operations of the present disclosure may be written in one or more programming languages or combinations thereof. The programming languages including, but not limited to, object-oriented programming languages such as Java, Smalltalk, C++, and also conventional procedural programming languages such as the “C” or similar programming languages. The program code may be executed entirely on the user's computer, partially on the user's computer, as a single-machine software package, partially on the user's computer and partially on a remote computer, or entirely on a remote computer or server. In situations involving a remote computer, the remote computer may be connected to the user computer via any kind of network, including a local area network (LAN) or a wide area network (WAN), or may be connected to an external computer.

The flowcharts and block diagrams in the drawings illustrate the structure, functionality, and operation of systems, methods, and computer program products that may be implemented by various embodiments of the present disclosure. At this point, each box in the flowcharts or block diagrams may represent a module, program segment, or portion of code that contains one or more executable instructions for implementing a specified logical function. It should also be noted that in some implementations as replacements, the functions labeled in the boxes may also occur in a different order than those labeled in the drawings. For example, two consecutively represented boxes may actually be executed substantially in parallel, and they may sometimes be executed in reverse order, depending on the function involved. It is also noted that each of the boxes in the block diagram and/or flowchart, and combinations of the boxes in the block diagram and/or flowchart, may be implemented with a specialized hardware-based system that performs the specified function or operation, or may be implemented with a combination of specialized hardware and computer instructions.

The modules, components, or units described as being involved in embodiments of the present disclosure may be implemented by way of software or may be implemented by way of hardware. The name of a module, component or unit does not constitute a limitation of the module, component or unit itself in a particular case.

The functions described above herein may be performed, at least in part, by one or more hardware logic components. For example, non-limitingly, exemplary hardware logic components that may be used include: field programmable gate arrays (FPGAs), application-specific integrated circuits (ASICs), application-specific standard products (ASSPs), systems-on-chip (SOCs), complex programmable logic devices (CPLDs), and the like.

The above description is only some embodiments of the present disclosure and an illustration of the technical principles utilized. Those skilled in the art should understand that the scope of the present disclosure is not limited to the technical solutions formed by a particular combination of the above technical features, but also covers other technical solutions formed by any combination of the above technical features or their equivalent features without departing from the above disclosure concept. For example, a technical solution formed by interchanging the above-described features with (but not limited to) technical features having similar functions disclosed in the present disclosure.

Although some particular embodiments of the present disclosure have been described in detail by way of examples, it should be understood by those skilled in the art that the above examples are for illustrative purposes only and are not intended to limit the scope of the present disclosure. Those skilled in the art should understand that the above embodiments may be modified without departing from the scope and spirit of the present disclosure. The scope of the present disclosure is limited by the claims.

1. A method for load processing, comprising:
acquiring a load state that is current for a target server, wherein the load state comprises an overload state or an underload state, and an overload detection cycle corresponding to the overload state is less than an underload detection cycle corresponding to the underload state; and
performing overload processing or underload processing on the target server based on the load state.

2. The method according to claim 1, further comprising:
acquiring an average load rate of a server cluster where the target server is located and a single-machine load rate of the target server; and
in response to, during the overload detection cycle, the average load rate being greater than a first threshold value, or the single-machine load rate being greater than a second threshold value, determining that the current load state of the target server is the overload state.

3. The method according to claim 2, further comprising:
in response to, during the underload detection cycle, the average load rate being less than a third threshold value, and the single-machine load rate being less than a fourth threshold value, determining that the current load state of the target server is the underload state, wherein the third threshold value is less than the first threshold value, and the fourth threshold value is less than the second threshold value.

4. The method according to claim 1, wherein the performing overload processing on the target server, comprises:
acquiring an accessor that accesses to the target server, and sending a multimedia data stream to the accessor; and
performing a hierarchical degradation strategy on the multimedia data stream in response to the target server being in the overload state, wherein the hierarchical degradation strategy is used to gradually reduce data transmission amount of the multimedia data stream.

5. The method according to claim 4, wherein the performing underload processing on the target processor, comprises:
performing hierarchical degradation strategy fallback on the multimedia data stream in response to the target server being in the underload state, wherein the hierarchical degradation strategy fallback is used to gradually increase the data transmission amount of the multimedia data stream.

6. The method according to claim 4, wherein the hierarchical degradation strategy comprises a plurality of levels; and
the performing a hierarchical degradation strategy on the multimedia data stream, comprises:
reducing the data transmission amount of the multimedia data stream level by level based on the plurality of levels included in the hierarchical degradation strategy.

7. The method according to claim 6, further comprising:
acquiring an accessor category corresponding to the accessor; and
reducing the data transmission amount of the multimedia data stream based on the accessor category.

8. The method according to claim 6, further comprising:
increasing a level of the hierarchical degradation strategy in response to the load state being the overload state;
or,
decreasing the level of the hierarchical degradation strategy in response to the load state being the underload state.

9. The method according to claim 5, wherein the hierarchical degradation strategy comprises a plurality of levels; and
the performing a hierarchical degradation strategy on the multimedia data stream, comprises:
reducing the data transmission amount of the multimedia data stream level by level based on the plurality of levels included in the hierarchical degradation strategy.

10. An electronic device, comprising:
at least one processor;
at least one memory, configured to store instructions executable for the at least one processor;
wherein the at least one processor is configured to execute the instructions to implement a method for load processing, and the method comprises:
acquiring a load state that is current for a target server; wherein the load state comprises an overload state or an underload state, and an overload detection cycle corresponding to the overload state is less than an underload detection cycle corresponding to the underload state; and
performing overload processing or underload processing on the target server based on the load state.

11. The electronic device according to claim 10, wherein the method further comprises:
acquiring an average load rate of a server cluster where the target server is located and a single-machine load rate of the target server; and
in response to, during the overload detection cycle, the average load rate being greater than a first threshold value, or the single-machine load rate being greater than a second threshold value, determining that the current load state of the target server is the overload state.

12. The electronic device according to claim 11, wherein the method further comprises:
in response to, during the underload detection cycle, the average load rate being less than a third threshold value, and the single-machine load rate being less than a fourth threshold value, determining that the current load state of the target server is the underload state, wherein the third threshold value is less than the first threshold value, and the fourth threshold value is less than the second threshold value.

13. The electronic device according to claim 10, wherein the performing overload processing on the target server, comprises:
acquiring an access party that accesses to the target server, and sending a multimedia data stream to the accessor; and
performing a hierarchical degradation strategy on the multimedia data stream in response to the target server being in the overload state, wherein the hierarchical degradation strategy is used to gradually reduce data transmission amount of the multimedia data stream.

14. The electronic device according to claim 13, wherein the performing underload processing on the target processor, comprises:
performing hierarchical degradation strategy fallback on the multimedia data stream in response to the target server being in the underload state, wherein the hierarchical degradation strategy fallback is used to gradually increase the data transmission amount of the multimedia data stream.

15. The electronic device according to claim 13, wherein the hierarchical degradation strategy comprises a plurality of levels; and
the performing a hierarchical degradation strategy on the multimedia data stream, comprises:
reducing the data transmission amount of the multimedia data stream level by level based on the plurality of levels included in the hierarchical degradation strategy.

16. A non-transitory computer-readable storage medium, wherein when the instructions in the non-transitory computer-readable storage medium are executed by a processor of an electronic device, the electronic device is caused to perform a method of load processing, and the method comprises:
acquiring a load state that is current for a target server; wherein the load state comprises an overload state or an underload state, and an overload detection cycle corresponding to the overload state is less than an underload detection cycle corresponding to the underload state; and
performing overload processing or underload processing on the target server based on the load state.

17. The non-transitory computer-readable storage medium according to claim 16, wherein the method further comprises:
acquiring an accessor that accesses to the target server, and sending a multimedia data stream to the accessor; and
in response to, during the overload detection cycle, the average load rate being greater than a first threshold value, or the single-machine load rate being greater than a second threshold value, determining that the current load state of the target server is the overload state.

18. The non-transitory computer-readable storage medium according to claim 17, wherein the method further comprises:
in response to, during the underload detection cycle, the average load rate being less than a third threshold value, and the single-machine load rate being less than a fourth threshold value, determining that the current load state of the target server is the underload state, wherein the third threshold value is less than the first threshold value, and the fourth threshold value is less than the second threshold value.

19. The non-transitory computer-readable storage medium according to claim 16, wherein the performing overload processing on the target server, comprises:
acquiring an accessor that accesses to the target server, and sending a multimedia data stream to the accessor; and
performing a hierarchical degradation strategy on the multimedia data stream in response to the target server being in the overload state, wherein the hierarchical degradation strategy is used to gradually reduce data transmission amount of the multimedia data stream.

20. The non-transitory computer-readable storage medium according to claim 19, wherein the performing underload processing on the target processor comprises:
performing hierarchical degradation strategy fallback on the multimedia data stream in response to the target server being in the underload state, wherein the hierarchical degradation strategy fallback is used to gradually increase the data transmission amount of the multimedia data stream.
